(19) United States
(12) Patent Application Publication
(10) Pub. No.: US 2016/0010457 A1
(43) Pub. Date: Jan. 14, 2016

(54) TURBINE WHEEL OF AN EXHAUST GAS TURBOCHARGER AND ASSOCIATED PRODUCTION METHOD

(71) Applicant: Bosch Mahle Turbo Systems GmbH & Co. KG, Stuttgart (DE)

(72) Inventors: Thomas Striedelmeyer, Stuttgart (DE); Jochen Schray, Oberriexingen (DE); Anton Angelusch, Waiblingen (DE); Andreas Strempel, Uhingen Allgemein (DE); Gunter Winkler, Stuttgart (DE); Senol Soeguet, Stuttgart (DE)

(21) Appl. No.: 14/794,760

(22) Filed: Jul. 8, 2015

(30) Foreign Application Priority Data
Jul. 9, 2014 (DE) 102014213343.2

(51) Int. Cl. F01D 5/02; B22F 3/22; B23K 26/00; B22F 5/00; B23K 15/00; B23K 26/342; F02B 37/00; B22F 3/105

(52) U.S. Cl. CPC F01D 5/02; F02B 37/00; B22F 3/225; B22F 3/1055; B22F 5/009; B23K 15/0086; B23K 15/0093; B23K 26/342; B23K 26/0006; F05D 2220/40; F05D 2240/24; F05D 2230/60; F05D 2230/23; F05D 2300/174; B33Y 10/00

(57) ABSTRACT

A turbine wheel for an exhaust gas turbocharger may include a body composed of a TiAl alloy via at least one of metal injection moulding, selective laser melting and electron beam melting. The body may include a plurality of blades each having an outlet blade root and an outlet blade tip disposed radially away from a rotation axis with respect to the outlet blade root. The body may have a quotient Q of a diameter d_{S} defined by each of the outlet blade tips to a diameter d_{N} defined by each of the oulet blade roots corresponding to the following relationship: Q=d_{S}/d_{N}>3.85.

### CROSS-REFERENCE TO RELATED APPLICATIONS

This application claims priority to German Patent Application No. 10 2014 213 343.2, filed Jul. 9, 2014, the contents of which are hereby incorporated by reference in its entirety.

### TECHNICAL FIELD

The present invention relates to a turbine wheel of an exhaust gas turbocharger. The invention furthermore relates to an exhaust gas turbocharger with such a turbine wheel and to a method for producing such.

### BACKGROUND

In addition to the proven turbine wheels made from nickel-based alloys, weight-optimised turbine wheels have increasingly come into consideration in recent years, which in particular utilise light metal alloys and ceramic materials. An advantage of weight optimised turbine wheels in this case is the reduction of the mass moment of inertia and because of this an improvement of the transient behaviour of an exhaust gas turbocharger equipped with such. Predestined for this purpose among other things is the use of titanium aluminides (γ-TiAl), since titanium aluminides have an approximately 50% lower density than conventionally used nickel-based alloys.

Today, these Ti-Al turbine wheels are mainly produced by casting processes. When casting nickel-based alloys and TiAl, the turbine wheel today is initially gated from the front, i.e. from the turbine wheel nose, wherein the casting process is subjected to some restrictions. A challenge during the casting process in particular is also the diameter of the turbine wheel nose or the diametrically narrowest cross section at the gating point. During the course of the casting process there are restrictions with respect to a minimal turbine wheel hub diameter or turbine wheel nose diameter, which directly influences the flow speed during the casting process or the solidification behaviour during casting. This minimal realisable hub diameter in turn creates restrictions with respect to the turbine wheel overall diameter.

### SUMMARY

The present invention therefore deals with the problem of stating an improved or at least an alternative embodiment for a turbine wheel of an exhaust gas turbocharger or generally of a supercharging device which does not only ensure high production quality but additionally also increases the efficiency of the turbine wheel.

According to the invention, this problem is solved through the subjects of the independent claims. Advantageous embodiments are subject of the dependent claims.

The present invention is based on the general idea of producing a turbine wheel of an exhaust gas turbocharger or a radial turbine wheel made from a TiAl alloy by means of a special production method, which at the same time makes possible reducing the diameter at the turbine wheel outlet blade root, i.e. in the region of the hub. According to the invention, this is ensured through metal injection moulding (MIM), selective laser melting (SLM) or electron beam melting (EBM), wherein in addition a quotient of a diameter at the turbine wheel outlet blade tips to a diameter at the turbine wheel outlet blade root is greater than 3.85. This value has materialised from tests and proved to be particularly effective so that in the present case the term limit value can already be used in the broadest sense. During metal injection moulding, a TiAl alloy mixed with a binder is injected as powder into an injection mould, wherein subsequently the turbine wheel is demoulded from the tool. This is followed by debinding and at the end sintering. The MIM method in this case differs from the casting method, in the case of which the turbine wheel form is produced by means of wax/ceramic. During the production of the turbine wheel from titanium aluminide by means of the MIM method the turbine wheel is “injection moulded” from the back, i.e. from a wheel back side/calotte, and not from the front as is the case during casting. This makes possible keeping the turbine wheel nose or the hub smaller with respect to the diameter than during the casting process, since there is no casting function as such and because of this the parameters such as flow speed during the casting process and solidification behaviour during the casting process which usually have to be considered during casting do not play any role. During electron beam melting (EBM), the titanium aluminide alloy is likewise present as powder, while a freely controllable electron beam serves as energy source for selectively melting the powder. The generated component is thus generated layer by layer in a vacuum or under an inert gas atmosphere. In the process, the powder is deposited layer by layer in the powder bed and defined regions exposed. The selective laser melting in this case works analogously to the EBM method, while a laser, however, is used for the selective layer build-up. In contrast with pure laser sintering, the material is completely melted during the SLM method. With the EBM/SLM method, the turbine wheel nose or turbine wheel hub has no casting function either and can for this reason be already reduced with respect to its diameter.

The core of the invention thus is a slimming of nose/hub on the turbine wheel outlet by producing the titanium aluminide turbine wheel by means of the mentioned methods, namely by means of metal injection moulding (MIM), electron beam melting (EBM) or selective laser melting (SLM) and thus a weight reduction.

Restrictions in the “slimming” of the turbine wheel nose must obviously be considered with respect to the turbine wheel handling in during finishing, the turbine wheel on the turbine wheel nose for example must still be grippable and with respect to a possible balancability sufficient material still has to be present for removal in the region of the turbine wheel nose plane. The production methods employed and described according to the invention additionally allow producing the turbine wheel with greater geometrical precision as a result of which the unbalance tends to be lower per se and because of this less balancing mass on the turbine wheel nose is required in order to be able to offset this unbalance.

By slimming the turbine wheel nose or turbine wheel hub major freedoms with respect to designing the mass throughput of the turbine wheel and with respect to realising smaller, lighter and inertia-optimised turbine wheels are generally obtained. By reducing the diameter of the turbine wheel at the turbine outlet in the region of the blade roots, the blades of the turbine wheel per se can be designed longer as a result of which a positive influence on the throughput can be achieved. A same throughput, by contrast, can even be achieved even when the blades have the same length as the previous turbine wheels, but because of the reduced turbine wheel hub diameter already start further inwardly and because of this the total diameter of the turbine wheel is reduced. By reducing the diameter in the region of the turbine wheel hub, material can be clearly saved as a result of which in particular the mass inertia of the turbine wheel and indirectly thereby the response behaviour of an exhaust gas turbocharger can be positively influenced.

Generally, the following substantial advantages are obtained through the turbine wheel according to the invention:
lower weight and/or reduced size,
lower material expenditure combined with reduced costs and improved eco-balance,
reduced mass moment of inertia,
new freedom with respect to designing the mass throughput,
an improvement of the centre of gravity of the rotor (turbine wheel-shaft combination) because of the lower mass

The advantages of the turbine wheel according to the invention in this case can be utilised both for a radial turbine and also for a diagonal turbine.

The invention, furthermore, is based on the general idea of equipping an exhaust gas turbocharger with a turbine wheel according to the invention described in the preceding paragraphs. Such a modified exhaust gas turbocharger has a clearly improved response behaviour since the turbine wheel has a clearly reduced mass and thus also a clearly reduced mass moment of inertia. Here, the turbine wheel can be diametrically reduced in size at the blade root of the turbine outlet (d_{N}) in order to achieve a higher exhaust gas mass throughput with this turbine wheel without having to take special measures on the turbine wheel blades. Conversely, this also makes possible using a turbine wheel with reduced turbine outer diameter that is more compact with respect to size, since with same exhaust gas mass throughput the turbine can be reduced in size both at the turbine inlet and also at the turbine outlet.

In addition, the present invention is based on the general idea of stating an improved method for producing a turbine wheel for an exhaust gas turbocharger, with which the turbine wheel is produced from a titanium aluminide alloy by means of metal injection moulding, selective laser melting or electron beam melting. At the same time, a minimal quotient of 3.85 is determined for a quotient of a diameter at the turbine wheel outlet blade tips to a diameter at the turbine wheel outlet blade root, so that the turbine wheel produced by means of the method according to the invention has a quotient of > than 3.85. The mentioned method in this case make possible a clearly increased production precision, in particular also with respect to complex blade structures, as a result of which it is possible to reduce the mass disposed in the region of the hub for offsetting unbalances.

Further important features and advantages of the invention are obtained from the subclaims, from the drawing and from the associated figure description with the help of the drawing.

It is to be understood that the features mentioned above and still to be explained in the following cannot only be used in the respective combination stated but also in other combinations or by themselves without leaving the scope of present invention.

A preferred exemplary embodiment of the invention is shown in the drawing and is explained in more detail in the following description.

### BRIEF DESCRIPTION OF THE DRAWINGS

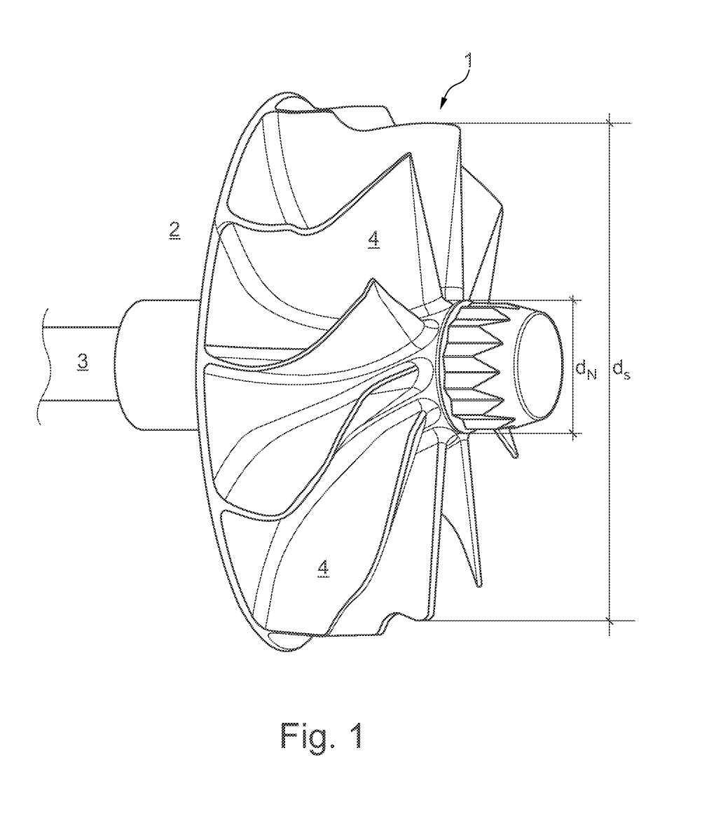

The sole FIG. 1 shows a turbine wheel according to the invention.

### DETAILED DESCRIPTION

In the case of FIG. 1, a turbine wheel 1 according to the invention, which can be designed as a turbine wheel in an exhaust gas turbocharger 2, has a quotient

$$Q = \frac{{d}_{s}}{{d}_{N}} > 3.85$$

In addition, the turbine wheel 1 according to the invention is produced from a titanium aluminide alloy by means of metal injection moulding (MIM), selective laser melting (SLM) or electron beam melting (EBM). The turbine wheel 1 in this case is connected to a shaft 3 (e.g. welded to a shaft 3) and in the process forms a rotor of the exhaust gas turbocharger 2.

By producing the turbine wheel 1 according to the invention by means of the mentioned production methods and by means of the titanium aluminide alloy, a clearly reduced weight compared with conventional turbine wheels which are based on nickel-based alloys can be achieved, while such a low weight also results in a reduced mass moment of inertia which has a positive effect on a response behaviour of the exhaust gas turbocharger 2. The reduction of the diameter of the turbine wheel at the turbine outlet in the region of the blade roots is due to the fact that because of the improved production precision by means of the mentioned production methods lower unbalances are present and because of this an offsetting mass for offsetting such unbalances can also be lower. Because of the mentioned production methods, no casting nose in the region of the hub has to be retained any longer, and the methods even allow building-up the turbine wheel 1 from its back side. By reducing the diameter d_{N} at the turbine wheel outlet blade root it is additionally possible, with otherwise same outer diameter, to design the individual blades 4 longer in radial direction, as a result of which the turbine wheel 1 altogether makes possible a higher throughput.

If the throughput is not to be changed, the diameter d_{N} at the turbine wheel outlet blade root reduced in this manner makes possible moving the blades 4 altogether radially towards the inside and because of this reduce the entire outer diameter of the turbine wheel 1, which has an advantageous effect on a required installation space of the turbine wheel and thus indirectly also on required installation space of the exhaust gas turbocharger 2. Because of this, freedoms which in particular were not known to date are obtained with respect to designing the mass throughput of the turbine wheel 1.

By reducing the mass of the turbine wheel 1 in the region of the hub, material as a whole can be saved as a result of which it is not only possible to go easy on resources and save material costs, but the environmental compatibility can be additionally improved.

1. A turbine wheel for an exhaust gas turbocharger, comprising: a body composed of a TiAl alloy via at least one of metal injection moulding, selective laser melting and electron beam melting, the body including a plurality of blades each having an outlet blade root and an outlet blade tip disposed radially away from a rotation axis with respect to the outlet blade root, wherein the body has a quotient Q of a diameter d_{S} defined by each of the outlet blade tips to a diameter d_{N} defined by each of the outlet blade roots corresponding to the following relationship:
Q=d_{S}/d_{N}>3.85.

2. An exhaust gas turbocharger, comprising: a turbine wheel composed of a TiAl alloy, the turbine wheel including a plurality of blades each having an outlet blade root and an outlet blade tip disposed radially away from a rotation axis with respect to the outlet blade root;
wherein the turbine wheel has a quotient Q of a diameter d_{S} defined by each of the blade tips to a diameter d_{N} defined by each of the outlet blade roots corresponding to the following relationship:
Q=d_{S}/d_{N}>3.85.

3. A method for producing a turbine wheel comprising the steps of:
providing a component including a plurality of blades via a powder metallurgy process from a TiAl alloy, wherein the plurality of blades each include an outlet blade root and an outlet blade tip disposed radially away from a rotation axis with respect to the blade root, the component defining a quotient Q of a diameter d_{S} defined by each of the outlet blade tips to a diameter d_{N} defined by each of the outlet blade roots corresponding to the following relationship:
Q=d_{S}/d_{N}>3.85, and
wherein powdered metallurgy process includes at least one of metal injection moulding, selective laser melting and electron beam melting.

4. The method according to claim 3, wherein the powdered metallurgy process is metal injection moulding, and further comprising the steps of debinding and sintering the component.

5. The method according to claim 3, wherein the component is a unitary structure.

6. The method according to claim 3, further comprising the steps of:
providing a shaft; and
mounting the component on the shaft.

7. The method according to claim 6, wherein mounting the component on the shaft includes welding the component to the shaft.

8. The turbine wheel according to claim 1, wherein the body is unitary.

9. The exhaust gas turbocharger according to claim 2, wherein the turbine wheel is formed via metal injection moulding.

10. The exhaust gas turbocharger according to claim 2, wherein the turbine wheel is formed via selective laser melting.

11. The exhaust gas turbocharger according to claim 2, wherein the turbine wheel is formed via electron beam welding.

12. The exhaust gas turbocharger according to claim 2, wherein the turbine wheel is unitary.
